(19) United States
(12) Patent Application Publication
(10) Pub. No.: US 2018/0298235 A1
(43) Pub. Date: Oct. 18, 2018

(54) Method For Bonding Rubber and Ethylene-Vinyl Acetate (EVA) Foam

(71) Applicants: Yuh-Jye Uang, Taichung City (TW); Chi-Shih Lee, Taichung City (TW)

(72) Inventors: Yuh-Jye Uang, Taichung City (TW); Chi-Shih Lee, Taichung City (TW)

(21) Appl. No.: 15/489,855

(22) Filed: Apr. 18, 2017

(51) Int. Cl. C09J 7/02; C08J 9/42; C09J 5/06; B32B 37/12; B32B 37/10; B32B 5/18; B32B 7/12; B32B 27/32; B32B 37/06

(52) U.S. Cl. CPC C09J 7/0242; B32B 2266/0221; C09J 5/06; C09J 7/0267; B32B 37/12; B32B 37/10; B32B 5/18; B32B 7/12; B32B 27/32; B32B 37/06; C08J 2323/08; C08J 2433/08; C08J 2433/10; C08J 2407/00; C08J 2409/06; C08J 2409/02; C08J 2409/00; C08J 2423/16; C08J 9/42

(57) ABSTRACT

A method for bonding a rubber and an ethylene-vinyl acetate (EVA) foam, comprising: placing the rubber and a hot melt adhesive film in a mold, with the rubber adhered by a first side of the hot melt adhesive film; hot pressing the hot melt adhesive film and the rubber to bond them together; placing the ethylene-vinyl acetate (EVA) foam in the mold a, with the ethylene-vinyl acetate (EVA) foam adhered to a second side of the hot melt adhesive film, and with the ethylene-vinyl acetate (EVA) foam and the rubber disposed on opposite sides of the hot melt adhesive film; hot pressing the ethylene-vinyl acetate (EVA) foam, the hot melt adhesive film, and the rubber to bond them together to form a final product; and removing the final product from the mold.

### BACKGROUND OF THE INVENTION

### 1. Field of the Invention

The present invention relates to a bonding method and, particularly, to a method for bonding a rubber and an ethylene-vinyl acetate (EVA) form.

### 2. Description of the Related Art

Conventionally, a solvent (toluene) is used for bonding an ethylene-vinyl acetate (EVA) form and a rubber since the ethylene-vinyl acetate (EVA) form and the rubber are unable to be bonded together directly. The process includes coating the solvent on joining surfaces of the ethylene-vinyl acetate (EVA) form and the rubber and bonding them from the joining surfaces manually. However, it is time-consuming and laborious, and therefore increasing the cost of manufacture.

The present invention is, therefore, intended to obviate or at least alleviate the problems encountered in the prior art.

### SUMMARY OF THE INVENTION

According to the present invention, a method for bonding a rubber and an ethylene-vinyl acetate (EVA) foam, comprising: placing the rubber and a hot melt adhesive film in a mold, with the hot melt adhesive film layer prepared by the following raw materials in parts by weight: a 60-90 parts by weight of polyethylene-ester copolymer, a 10-40 parts by weight of rubber, a 1-15 parts by weight of thermoplastic polyolefin, and a 5-25 parts by weight of auxiliary, with the rubber adhered by a first side of the hot melt adhesive film, and with sulfur added in the mold; hot pressing a stack of the hot melt adhesive film and the rubber to bond the hot melt adhesive film and the rubber; placing the ethylene-vinyl acetate (EVA) foam in the mold and on a second side of the hot melt adhesive film, with the ethylene-vinyl acetate (EVA) foam adhered by the second side of the hot melt adhesive film, and with the ethylene-vinyl acetate (EVA) foam and rubber on opposite sides of the hot melt adhesive film; hot pressing a stack of the ethylene-vinyl acetate (EVA) foam, the hot melt adhesive film, and the rubber to bond the ethylene-vinyl acetate (EVA) foam, the hot melt adhesive film, and the rubber to form a final product; and removing the final product from the mold.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is an objective of the present invention to provide a method for bonding the rubber and the ethylene-vinyl acetate (EVA) foam effortlessly, economically, with fewer materials needed, and effectively than conventional methods.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a flow chart illustrating a method for bonding a rubber and an ethylene-vinyl acetate (EVA) foam in accordance with the present invention.

FIG. 2 is a top view showing the rubber and a hot melt adhesive film placed in a mold, with the hot melt adhesive film disposed on top of the rubber.

FIG. 2A is a cross-sectional view taken along line 2A-2A of FIG. 2.

FIG. 3 is a top view continued from FIG. 2 and showing the ethylene-vinyl acetate (EVA) foam disposed in the mold.

FIG. 3A is a cross-sectional view taken along line 3A-3A of FIG. 3, with the ethylene-vinyl acetate (EVA) foam and the rubber bonded by the hot melt adhesive film.

FIG. 4 is a top view showing a final product removed from the mold and including the ethylene-vinyl acetate (EVA) foam and the rubber being bonded.

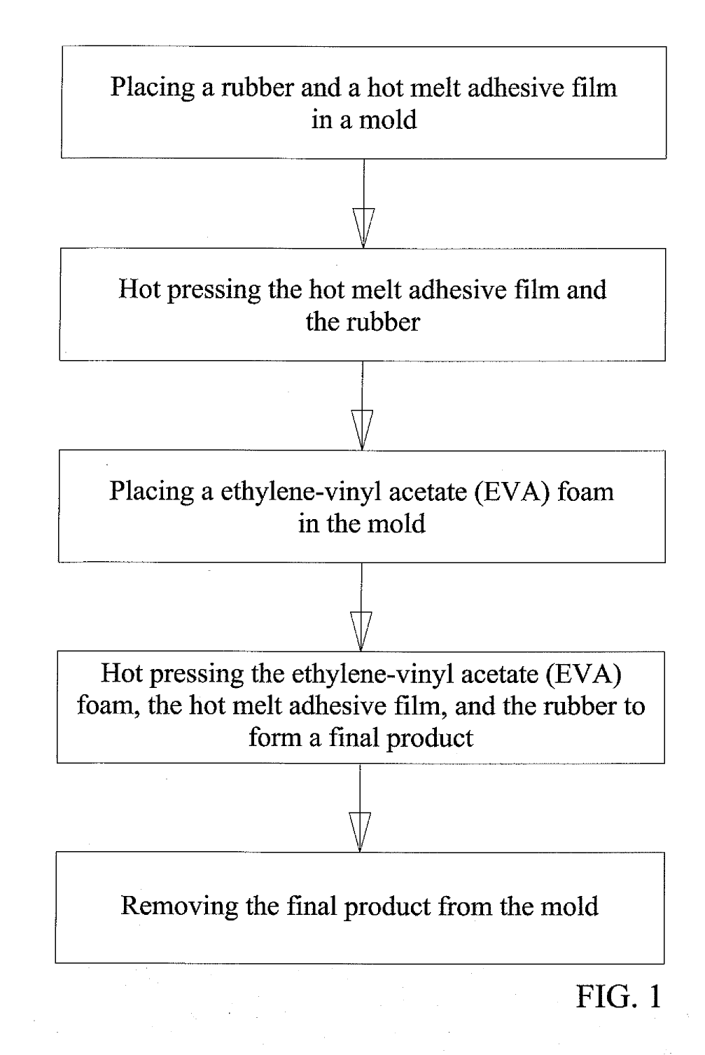

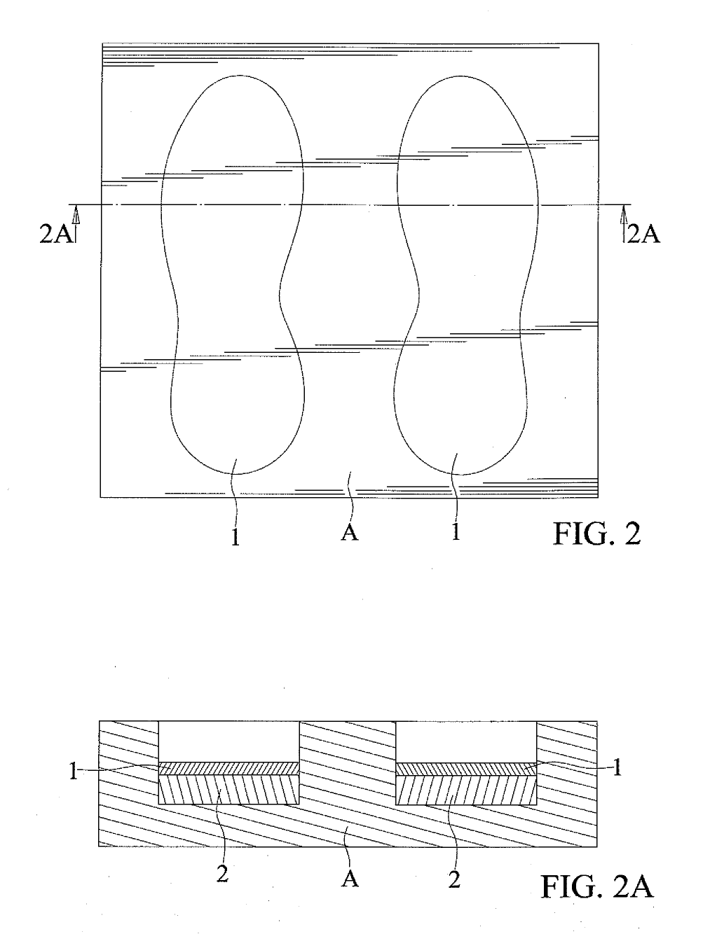

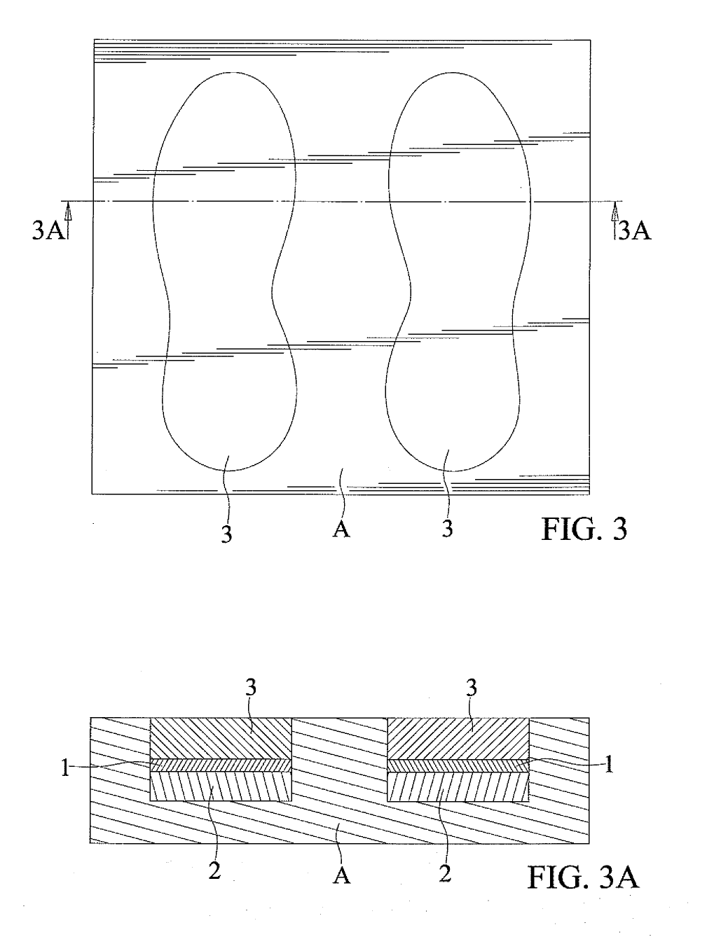

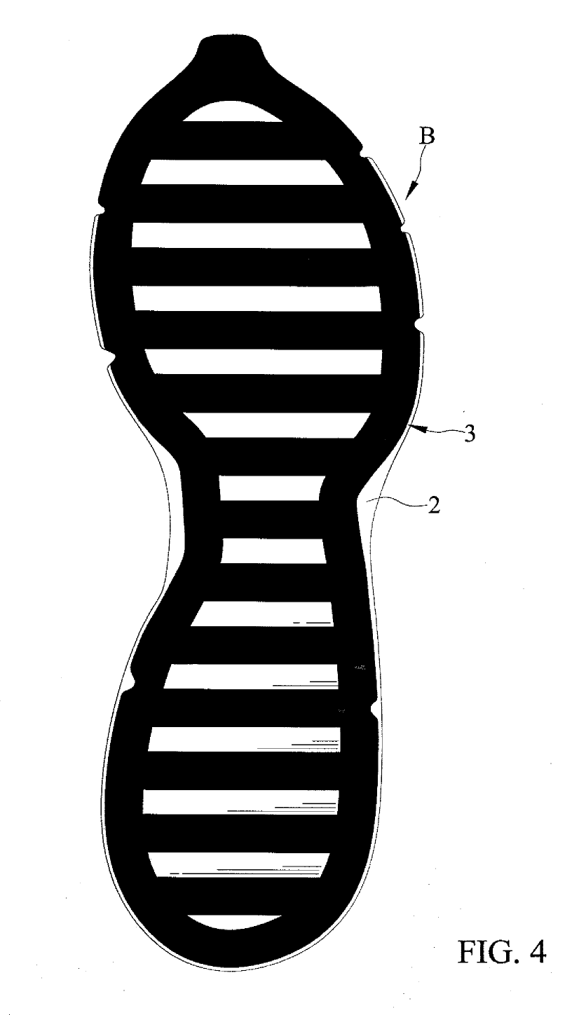

### DETAILED DESCRIPTION OF THE INVENTION

A method for bonding a rubber 2 and an ethylene-vinyl acetate (EVA) foam 3, comprising: placing the rubber 2 and a hot melt adhesive film 1 in a mold A, with the rubber 2 adhered by a first side of the hot melt adhesive film 1, and with sulfur added in the mold A; hot pressing a stack of the hot melt adhesive film 1 and the rubber 2 to bond the hot melt adhesive film 1 and the rubber 2; placing the ethylene-vinyl acetate (EVA) foam 3 in the mold A and on a second side of the hot melt adhesive film 1, with the ethylene-vinyl acetate (EVA) foam 3 adhered by the second side of the hot melt adhesive film 1, and with the ethylene-vinyl acetate (EVA) foam 3 and rubber 2 on opposite sides of the hot melt adhesive film 1; hot pressing a stack of the ethylene-vinyl acetate (EVA) foam 3, the hot melt adhesive film 1, and the rubber 2 to bond the ethylene-vinyl acetate (EVA) foam 3, the hot melt adhesive film 1, and the rubber 2 to form a final product B; and removing the final product B from the mold A.

The hot melt adhesive film 1 is configured for bonding the rubber 2 and the ethylene-vinyl acetate (EVA) foam 3 in a manner that the rubber 2 and the ethylene-vinyl acetate (EVA) foam 3 can connect together securely, effortlessly, economically, with fewer materials needed, and effectively.

The hot pressing temperature is achieved at a temperature in a range of 140 to 180 degrees Celsius and for a duration of time in a range of 3 to 8 minutes.

Preferably, the hot pressing temperature is achieved at a temperature of 155 degrees Celsius and for the duration of 5 minutes.

The hot melt adhesive film 1 is prepared by the following raw materials in parts by weight: a 60-90 parts by weight of polyethylene-ester copolymer, a 10-40 parts by weight of rubber, a 1-15 parts by weight of thermoplastic polyolefin, and a 5-25 parts by weight of auxiliary.

Preferably, the polyethylene-ester copolymer is 75-85 parts by weight. Preferably, the rubber is 10-30 parts by weight. Preferably, the auxiliary are 10-20 parts by weight.

The polyethylene-ester copolymer is one of the following kinds: a polyethylene-vinyl acetate copolymer, a polyethylene methyl acrylate copolymer, a polyethylene ethyl acrylate copolymer, a butyl acrylate copolymer, or a blend of two or more of said kinds.

The rubber is natural rubber, or synthetic rubber, or a blend of said natural rubber and said synthetic rubber, and wherein said synthetic rubber is one of the following kinds: a chloroprene rubber (CR), a styrene-butadiene rubber (SBR), a polybutadiene rubber (BR), a acrylonitrile butadiene rubber (NBR), a polyisoprene rubber (IR), a isobutylene isoprene butyl rubber (IIR), an ethylene propylene copolymer (EPR), an ethylene propylene diene monomer (EPDM), or a blend of two or more of said kinds.

The thermoplastic polyolefin is one of the following kinds: a high density polyethylene, a linear low density polyethylene, a polypropylene homopolymer, a polypropylene copolymer, an ethylene propylene copolymer, a 1,2-polybutadiene, or a blend of two or more of said kinds.

The auxiliary is one of the following kinds: a tackifier, a plasticizer, a filler, a rubber vulcanizing accelerator, a rubber activator, a softener, a rubber scorch retarder, an initiator, a crosslinking agent, a catalyst, an antiozonant, an antioxidant, an additive, or a blend of two or more of said kinds. The additive is vulcanizator or silane coupling agent.

The tackifiers is one of the following kinds: a rosin ester, a polymerized rosin, a terpene, a styrene terpene, a polyterpene phenolic resin, a petroleum resin, a modified petroleum resin, or a blend of two or more of said kinds.

The plasticizer is one of the following kinds: a mineral oil, a polybutylene, an isoprene rubber, or a blend of two or more of said kinds.

The filler is one of the following kinds: a kaolin, a mica, a titanium dioxide, a silica, a talc, a carbon black, or a blend of two or more of said kinds.

The rubber vulcanizing accelerator is one of the following kinds: a thiazole vulcanization accelerator, a sulfonamide type, a guanidine type, a dithio carbamate type, a thiourea type, a thiurams type, or a blend of two or more of said kinds.

The rubber activator is one of the following kinds: a zinc oxide, a magnesium oxide, a calcium oxide, a stearate, or a blend of two or more of said kinds.

The softener is one of the following kinds: a mineral oil, a liquid paraffin, a linseed oil, a coco oil, a paraffin, a carnauba wax, a stearate, a palmitic acid, or a blend of two or more of said kinds.

The rubber scorch retarder is one of the following kinds: a phthalic anhydride, a salicylic acid, a benzoic acid, a N-nitrosodiphenylamine, a phthalic imide sulfenamide or a blend of two or more of said kinds.

The antiozonant is one of the following kinds: a microcrystalline wax, a paraffin, a natural asphalt, or a blend of two or more of said kinds.

The initiator is an organic peroxide initiator.

The crosslinking agent is a closed diisocyanate.

The catalyst is dibutyl tin dilaurate and/or stannous octoate.

The antioxidant is one of the following kinds: a N-(1,3-Dimethylbutyl), a N′-phenyl-p-phenylenediamine (6PPD), a diphenyl-p-phenylenediamine (DPPD), an octylated diphenylamine (ODPA), 2-mercapto-benzimidazole (MB), a 2,6-Di-tert-butyl-4-methylphenol (BHT), or a blend of two or more of said kinds.

The vulcanizing agent is sulfur or sulfur donor vulcanizing agent for example: 4,4′-dithiodimorpholine.

The silane coupling agent is one of the following kinds is n-octyltriethoxysilane, (3-glycidoxypropyl)methyldiethoxysilane or derivatives of triethoxysilane, sodium polysulphide or a blend of two or more of said kinds.

In the embodiment, 60 kg of polyethylene-ester copolymer, 20 kg of a natural rubber, 5 kg of a thermoplastic polyolefin, 4 kg of a tackifier, 0.7 kg of a stearic acid, 1.5 kg of a microcrystalline wax, 1 kg of a zinc oxide, 0.6 kg of sulfur, a mixture of 0.35 kg of a 2,2′-dibenzothiaolyl disulfide (MBTS) and 0.2 kg of an Irganox® 1010 antioxidant are kneaded by a kneader. Then a combined mixture of set forth ingredients are calendered to produce an unvulcanized hot melt adhesive film 1.

In view of the foregoing, the hot melt adhesive film 1 is configured for bonding the rubber 2 and the ethylene-vinyl acetate (EVA) foam 3. Furthermore, the rubber 2 and the ethylene-vinyl acetate (EVA) foam 3 can be interconnected effortlessly, economically, with fewer materials needed, and most importantly, effectively than conventional methods.

The foregoing is merely illustrative of the principles of this invention and various modifications can be made by those skilled in the art without departing from the scope and spirit of the invention.

What is claimed is:

1. A method for bonding a rubber and an ethylene-vinyl acetate (EVA) foam, comprising:
placing the rubber and a hot melt adhesive film in a mold, with the hot melt adhesive film layer prepared by the following raw materials in parts by weight: a 60-90 parts by weight of polyethylene-ester copolymer, a 10-40 parts by weight of rubber, a 1-15 parts by weight of thermoplastic polyolefin, and a 5-25 parts by weight of auxiliary, with the rubber adhered by a first side of the hot melt adhesive film, and with sulfur added in the mold;
hot pressing a stack of the hot melt adhesive film and the rubber to bond the hot melt adhesive film and the rubber;
placing the ethylene-vinyl acetate (EVA) foam in the mold and on a second side of the hot melt adhesive film, with the ethylene-vinyl acetate (EVA) foam adhered by the second side of the hot melt adhesive film, and with the ethylene-vinyl acetate (EVA) foam and rubber on opposite sides of the hot melt adhesive film;
hot pressing a stack of the ethylene-vinyl acetate (EVA) foam, the hot melt adhesive film, and the rubber to bond the ethylene-vinyl acetate (EVA) foam, the hot melt adhesive film, and the rubber to form a final product; and
removing the final product from the mold.

2. The method according to claim 1, wherein said polyethylene-ester copolymer is 75-85 parts by weight, said rubber is 10-30 parts by weight, and said auxiliary is 10-20 parts by weight.

3. The method according to claim 1, wherein said polyethylene-ester copolymer is one of the following kinds: a polyethylene-vinyl acetate copolymer, a polyethylene methyl acrylate copolymer, a polyethylene ethyl acrylate copolymer, a butyl acrylate copolymer, or a blend of two or more of said kinds.

4. The method according to claim 1, wherein said rubber is natural rubber, or synthetic rubber, or a blend of said natural rubber and said synthetic rubber, and wherein said synthetic rubber is one of the following kinds: a chloroprene rubber (CR), a styrene-butadiene rubber (SBR), a polybutadiene rubber (BR), a acrylonitrile butadiene rubber (NBR), a polyisoprene rubber (IR), a isobutylene isoprene butyl rubber (IIR), an ethylene propylene copolymer (EPR), an ethylene propylene diene monomer (EPDM), or a blend of two or more of said kinds.

5. The method according to claim 1, wherein said thermoplastic polyolefin is one of the following kinds: a high density polyethylene, a linear low density polyethylene, a polypropylene homopolymer, a polypropylene copolymer, an ethylene propylene copolymer, a 1,2-polybutadiene, or a blend of two or more of said kinds.

6. The method according to claim 1, wherein said auxiliary is one of the following kinds: a tackifier, a plasticizer, a filler, a rubber vulcanizing accelerator, a rubber vulcanizing agent, a rubber activator, a softener, a rubber scorch retarder, an initiator, a crosslinking agent, a catalyst, an antiozonant, an antioxidant, an additive, or a blend of two or more of said kinds, and wherein said additive is vulcanizator or silane coupling agent.

7. The method according to claim 6, wherein said tackifiers is one of the following kinds: a rosin ester, a polymerized rosin, a terpene, a styrene terpene, a polyterpene phenolic resin, a petroleum resin, a modified petroleum resin, or a blend of two or more of said kinds, wherein said plasticizer is one of the following kinds: a mineral oil, a polybutylene, an isoprene rubber, or a blend of two or more of said kinds, wherein said filler is one of the following kinds: a kaolin, a mica, a titanium dioxide, a silica, a talc, a carbon black, or a blend of two or more of said kinds, wherein said rubber vulcanizing accelerator is one of the following kinds: a thiazole vulcanization accelerator, a sulfonamide type, a guanidine type, a dithio carbamate type, a thiourea type, a thiurams type, or a blend of two or more of said kinds, wherein said rubber activator is one of the following kinds: a zinc oxide, a magnesium oxide, a calcium oxide, a stearate, or a blend of two or more of said kinds, wherein said softener is one of the following kinds: a mineral oil, a liquid paraffin, a linseed oil, a coco oil, a paraffin, a carnauba wax, a stearate, a palmitic acid, or a blend of two or more of said kinds, wherein said rubber scorch retarder is one of the following kinds: a phthalic anhydride, a salicylic acid, a benzoic acid, a N-nitrosodiphenylamine, a phthalic imide sulfenamide or a blend of two or more of said kinds, wherein said antiozonant is one of the following kinds: a microcrystalline wax, a paraffin, a natural asphalt, or a blend of two or more of said kinds, wherein said initiator is an organic peroxide initiator, wherein said crosslinking agent is a closed diisocyanate, wherein said catalyst is dibutyl tin dilaurate and/or stannous octoate, wherein the antioxidant is one of the following kinds: a N-(1,3-Dimethylbutyl), a N′-phenyl-p-phenylenediamine (6PPD), a diphenyl-p-phenylenediamine (DPPD), an octylated diphenylamine (ODPA), 2-mercapto-benzimidazole (MB), a 2,6-Di-tert-butyl-4-methylphenol (BHT), or a blend of two or more of said kinds, wherein said vulcanizing agent is sulfur or sulfur donor vulcanizing agent for example: 4,4′-dithiodimorpholine, and wherein silane coupling agent is one of the following kinds is n-octyltriethoxysilane, (3-glycidoxypropyl)methyldiethoxysilane or derivatives of triethoxysilane, sodium polysulphide or a blend of two or more of said kinds.

8. The method according to claim 1, wherein the hot pressing temperature is achieved at a temperature in a range of 140 to 180 degrees Celsius and for a duration of time in a range of 3 to 8 minutes.

9. The method according to claim 8, wherein the hot pressing temperature is achieved at a temperature of 155 degrees Celsius and for the duration of 5 minutes.
